(19) United States
(12) Patent Application Publication
(10) Pub. No.: US 2026/0339543 A1
(43) Pub. Date: Oct. 29, 2026

(54) DATA PARTITIONING IN HYBRID OBJECT STORAGE

(71) Applicant: Rakuten Symphony, Inc., Tokyo (JP)

(72) Inventors: Nilesh Sitaram Somani, San Mateo, CA (US); Sree Nandan Atur, San Mateo, CA (US)

(21) Appl. No.: 19/192,578

(22) Filed: Apr. 29, 2025

(51) Int. Cl. G06F 3/06

(52) U.S. Cl. CPC G06F 3/0655; G06F 3/0604; G06F 3/068

(57) ABSTRACT

A system for object storage includes a plurality of computing platforms each being at least one of an on-premise computing platforms or a cloud computing platform, each computing platform of the plurality of computing platforms hosting a datastore and a metastore for the datastore. One or more gateways execute on one or more computing platforms of the plurality of computing platforms. The one or more gateways are configured to: receive a request to store an object; identify a bucket associated with the object according to one or more attributes associated with the object; identify a tag mapped to the bucket; and transmit the object to a corresponding computing platform of the plurality of computing platforms associated with the tag.

### FIELD

The present disclosure relates to data partitioning in hybrid object storage.

### BACKGROUND

The information disclosed in this background section is only for enhancement of understanding of the general background of the disclosure and should not be taken as an acknowledgement or any form of suggestion that this information forms the prior art already known to a person skilled in the art.

Many computing tasks may benefit from storing data as objects in a datastore. Often, a metastore stores metadata for the objects to facilitate management of the objects. The objects may be stored with recovery information, such as using erasure coding. One common application is to store training data entries for training a machine learning model in a datastore. Many cloud computing platforms provide virtualized computing resources that are specialized for training machine learning models and also provide virtualized storage for storing a datastore.

### SUMMARY

In one aspect, a system for object storage includes a plurality of computing platforms each being at least one of an on-premise computing platform or a cloud computing platform, each computing platform of the plurality of computing platforms hosting a datastore and a metastore for the datastore. One or more gateways execute on one or more computing platforms of the plurality of computing platforms. The one or more gateways are configured to: receive a request to store an object; identify a bucket associated with the object according to one or more attributes associated with the object; identify a tag mapped to the bucket; and transmit the object to a corresponding computing platform of the plurality of computing platforms associated with the tag.

In another aspect, a method for object storage includes receiving, by a gateway, a request to store an object, the gateway being connected to a plurality of computing platforms, each computing platform of the plurality of computing platforms being at least one of an on-premise computing platform or a cloud computing platform and hosting a datastore and a metastore for the datastore. The method includes identifying, by the gateway, a bucket associated with the object according to one or more attributes associated with the object. The method includes identifying, by the gateway, a tag mapped to the bucket. The method includes transmitting, by the gateway, the object to a corresponding computing platform of the plurality of computing platforms associated with the tag.

In another aspect, a non-transitory computer readable medium storing executable code that, when executed by a computing device, causes the computing device to receive, by a gateway, a request to store an object, the gateway being connected to a plurality of computing platforms, each computing platform of the plurality of computing platforms being at least one of an on-premise computing platforms or a cloud computing platform and hosting a datastore and a metastore for the datastore. The gateway identifies a bucket associated with the object according to one or more attributes associated with the object. The gateway identifies a tag mapped to the bucket. The gateway transmits the object to a corresponding computing platform of the plurality of computing platforms associated with the tag.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a schematic block diagram of a network environment in which containers may be deployed in accordance with an embodiment;

FIG. 2 is a schematic block diagram showing components for implementing a partitioned datastore and metastore in accordance with an embodiment;

FIG. 3 is a process flow diagram of a method for implementing a partitioned datastore and metastore in accordance with an embodiment; and

FIG. 4 is a schematic block diagram of an example computing device suitable for implementing methods in accordance with embodiments of the disclosure.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

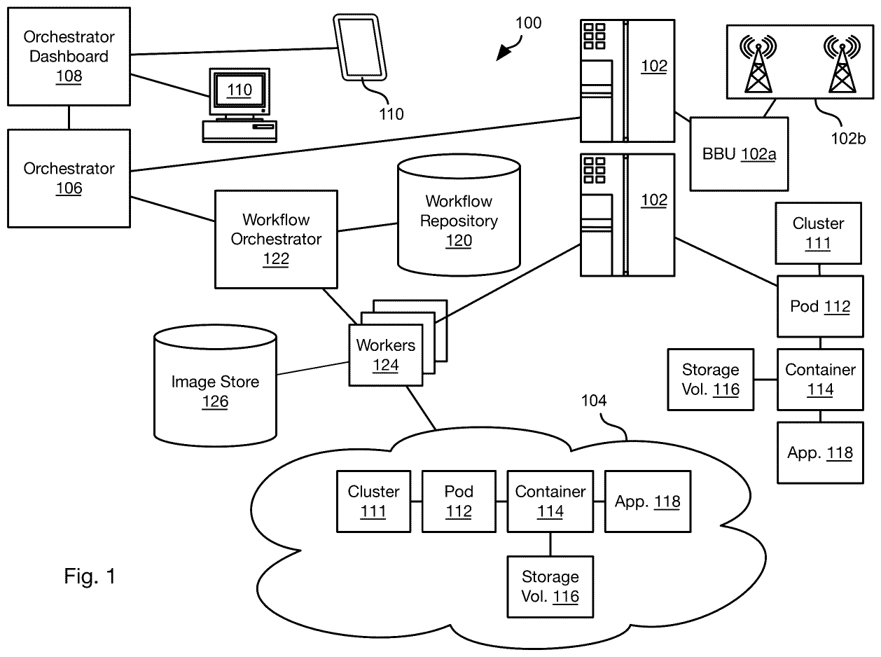

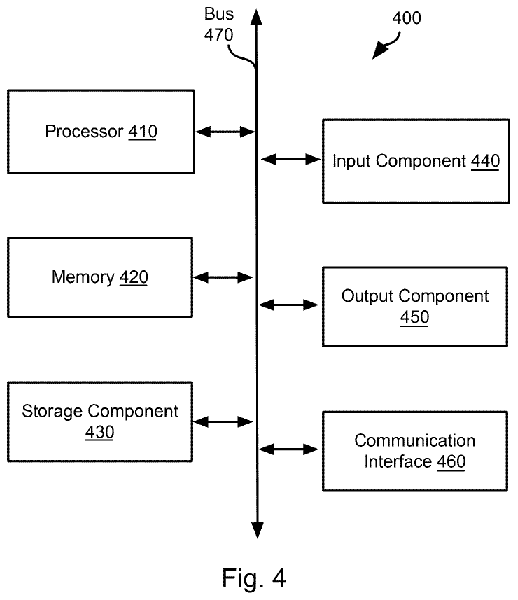

FIG. 1 illustrates an example network environment 100 in which the systems and methods disclosed herein may be used. The components of the network environment 100 may be connected to one another by a network such as a local area network (LAN), wide area network (WAN), the Internet, a backplane of a chassis, or other type of network. The components of the network environment 100 may be connected by wired or wireless network connections. The network environment 100 includes a plurality of servers 102. Each of the servers 102 may include one or more computing devices, such as a computing device having some or all of the attributes of the computing device 400 of FIG. 4.

Computing resources may also be allocated and utilized within a cloud computing platform 104, such as amazon web services (AWS), GOOGLE CLOUD, AZURE, or other cloud computing platform. Cloud computing resources may include purchased physical storage, processor time, memory, and/or networking bandwidth in units designated by the provider by the cloud computing platform. Accordingly, references to a server 102 herein may also refer to a virtualized server implemented by computing nodes of a cloud computing platform 104.

In some embodiments, some or all of the servers 102 may function as edge servers in a telecommunication network. The servers 102 may function as a distributed unit (DU) or central unit (CU) according to the open radio access network (O-RAN) standard. The servers 102 may implement a telecommunications cloud including DUs and CUs. For example, some or all of the servers 102 may be coupled to baseband units (BBU) 102a that provide translation between radio frequency signals output and received by antennas 102b and digital data transmitted and received by the servers 102. For example, each BBU 102a may perform this translation according to a cellular wireless data protocol (e.g., 4G, 5G, etc.). In some embodiments, a BBU 102 a may be a gNodeB according to the 5G protocol.

An orchestrator 106 provisions computing resources to application instances 118 of one or more different application executables, such as according to a manifest that defines requirements of computing resources for each application instance. The manifest may define dynamic requirements defining the scaling up or scaling down of a number of application instances 118 and corresponding computing resources in response to usage. The orchestrator 106 may include or cooperate with a utility such as KUBERNETES to perform dynamic scaling up and scaling down the number of application instances 118. In some embodiments, the orchestrator 106 may be or include a service management and orchestration (SMO) platform according to the O-RAN standard.

An orchestrator 106 may execute on a computer system that is distinct from the servers 102 and is connected to the servers 102 by a network that requires the use of a destination address for communication, such as using a networking including ethernet protocol, internet protocol (IP), Fibre Channel, or other protocol, including any higher-level protocols built on the previously-mentioned protocols, such as user datagram protocol (UDP), transport control protocol (TCP), or the like.

The orchestrator 106 may cooperate with the servers 102 to initialize and configure the servers 102. For example, each server 102 may cooperate with the orchestrator 106 to obtain a gateway address to use for outbound communication and a source address assigned to the server 102 for use in inbound communication. The server 102 may cooperate with the orchestrator 106 to install an operating system on the server 102.

The orchestrator 106 may be accessible by way of an orchestrator dashboard 108. The orchestrator dashboard 108 may be implemented as a web server or other server-side application that is accessible by way of a browser or client application executing on a user computing device 110, such as a desktop computer, laptop computer, mobile phone, tablet computer, or other computing device.

The orchestrator 106 may cooperate with the servers 102 in order to provision computing resources of the servers 102 and instantiate components of a distributed computing system on the servers 102 and/or on the cloud computing platform 104. For example, the orchestrator 106 may ingest a manifest defining the provisioning of computing resources to, and the instantiation of, components such as a cluster 111, pod 112 (e.g., KUBERNETES pod), container 114 (e.g., DOCKER container), storage volume 116, and an application instance 118. The orchestrator 106 may then allocate computing resources and instantiate the components according to the manifest.

The manifest may define requirements such as network latency requirements, affinity requirements (same node, same chassis, same rack, same data center, same cloud region, etc.), anti-affinity requirements (different node, different chassis, different rack, different data center, different cloud region, etc.), as well as minimum provisioning requirements (number of cores, amount of memory, etc.), performance or quality of service (QoS) requirements, or other constraints. The orchestrator 106 may therefore provision computing resources in order to satisfy or approximately satisfy the requirements of the manifest.

The instantiation of components and the management of the components may be implemented by means of workflows. A workflow is a series of tasks, executables, configuration, parameters, and other computing functions that are predefined and stored in a workflow repository 120. A workflow may be defined to instantiate each type of component (cluster 111, pod 112, container 114, storage volume 116, application instance 118, etc.), monitor the performance of each type of component, repair each type of component, upgrade each type of component, replace each type of component, copy (snapshot, backup, etc.) and restore from a copy each type of component, and other tasks. Some or all of the tasks performed by a workflow may be implemented using KUBERNETES or other utility for performing some or all of the tasks.

The orchestrator 106 may instruct a workflow orchestrator 122 to perform a task with respect to a component. In response, the workflow orchestrator 122 retrieves the workflow from the workflow repository 120 corresponding to the task (e.g., the type of task (instantiate, monitor, upgrade, replace, copy, restore, etc.) and the type of component. The workflow orchestrator 122 then selects a worker 124 from a worker pool and instructs the worker 124 to implement the workflow with respect to a server 102 or the cloud computing platform 104. The instruction from the orchestrator 106 may specify a particular server 102, cloud region or cloud provider, or other location for performing the workflow. The worker 124, which may be a container, then implements the functions of the workflow with respect to the location instructed by the orchestrator 106. In some implementations, the worker 124 may also perform the tasks of retrieving a workflow from the workflow repository 120 as instructed by the workflow orchestrator 122. The workflow orchestrator 122 and/or the workers 124 may retrieve executable images for instantiating components from an image store 126.

The servers 102 executing clusters 111 may have variable utilization over time and may therefore have additional clusters 111 instantiated thereon in response to utilization. Using the approach described herein, servers 102 are selected for instantiation of a cluster in order to reduce increases in energy utilization.

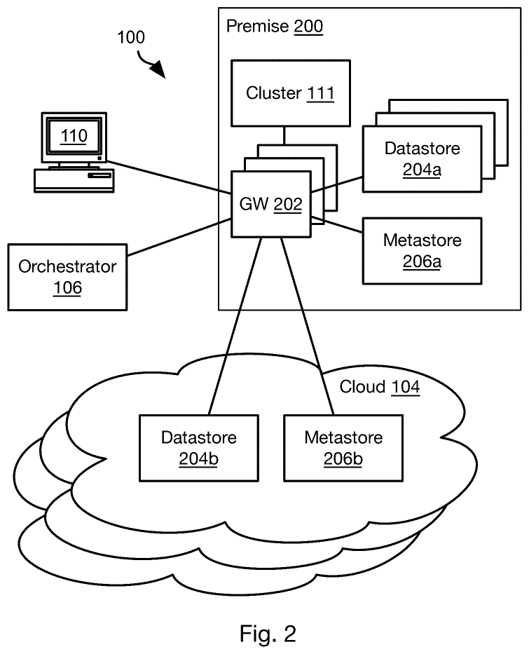

Referring to FIG. 2, in some embodiments, a so-called “stretch cluster” may be implemented in the network environment 100. A stretch cluster is a single cluster 111 that spans multiple platforms. For example, a stretch cluster may be a cluster 111 (e.g., implemented using a cluster manager) that includes pods 112, containers 114, storage volumes 116, and/or application instances 118 on multiple platforms. As used herein a “platform” may refer to on-premise servers 102 or one of any number of cloud computing platforms 104. In one particularly relevant example, a cluster 111 may be a stretch cluster that includes datastores 204a, 204b and corresponding metastores 206a, 206b on multiple platforms, such as on the servers 102 of an on-premise platform 200 and on one or more cloud computing platforms 104. The datastores 204a, 204b and metastores 206a, 206b may be a datastore such as GOOGLE CLOUD DATASTORE, AMAZON S3, SNOWFLAKE, AZURE DATA LAKE STORAGE, DATABRICKS DELTA LAKE, or the like.

The cluster 111 may host one or more gateways 202 that facilitates access to the datastores 204a, 204b and metastores 206a, 206b, such as in response to requests from a user computing device 110. In the illustrated embodiment, the gateways 202 are located on the on-premise platform 200. However, the one or more gateways 202 may additionally or alternatively execute in one or more of the cloud computing platforms 104.

A stretch cluster has the advantage of providing a large pool of possible computing and storage resources to instantiate pods 112, containers 114, and storage volumes 116. However, some tasks require data and the executable processing the data to be collocated. For example, a cloud computing platform 104 may provide a graphics processing unit (GPU) farm that is well suited for artificial intelligence (AI) applications. Such a cloud computing platform 104 may require that the data processed by the GPU farm be stored in the cloud computing platform. However, moving data to the cloud computing platform 104 takes time and charges may be incurred in order to extract the results of processing form the cloud computing platform 104. In another example, erasure coding enables multiple blocks of data to represent original data such that the original data can be recovered even if a certain number of the blocks is lost. If such blocks are stored in different platforms, performing erasure coding and recovery may require movements of large amounts of data and incur delays.

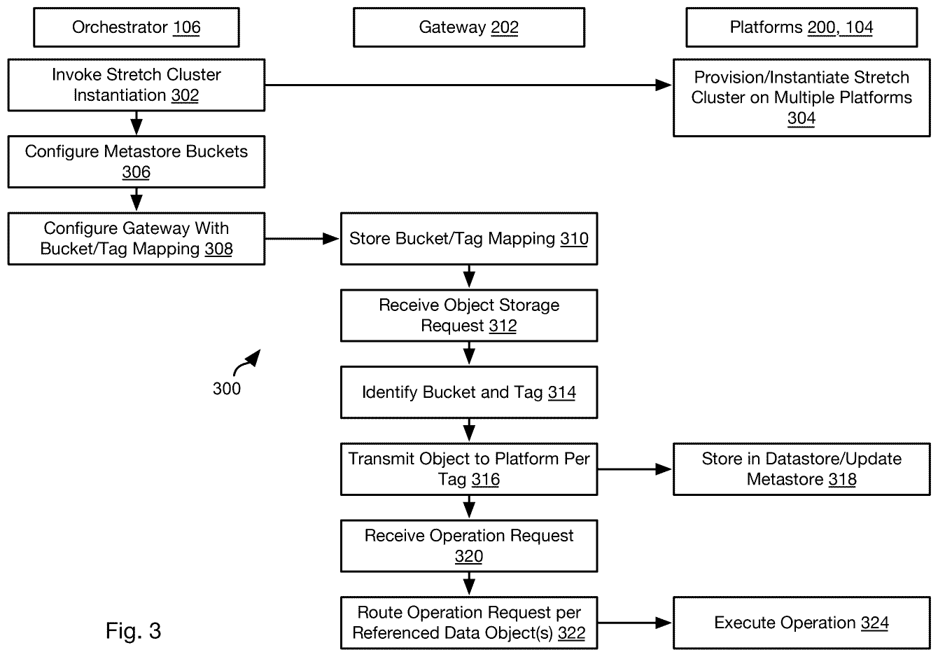

FIG. 3 illustrates an example method 300 for implementing a stretch cluster that provides the advantage of pooling computing and storage resources from multiple platforms while eliminating the deficiencies of prior approaches. Although the method 300 is particularly useful for stretch clusters, the method 300 may also be used in other contexts in which multiple options exist for the storing of objects in a datastore and corresponding metastore.

An orchestrator 106, such as KUBERNETES or other type of orchestrator, or a user directly, may invoke instantiation of a stretch cluster 111 at step 302. The stretch cluster may then be provisioned and instantiated on multiple platforms 200, 104 at step 304. Provisioning may include allocating computing, storage, memory, networking, or other resources on multiple platforms 200, 104. Instantiating may include creating pods 112, containers 114, storage volumes 116, and/or one or more applications instances on the multiple platforms 200, 104. Step 304 may include instantiating one or more gateways 202, datastores 204a, 204b, and/or metastores 206a, 206b on one or more of the multiple platforms 200, 104 using resources provisioned at step 304. The one or more gateways 202, datastores 204a, 204b, and/or metastores 206a, 206b may be application instances 118 executing within containers 114 and pods 112 and using storage provided by storage volumes 116.

The orchestrator 106 may configure metastore buckets at step 306. Each metastore 206a, 206b on each platform may be assigned one or more buckets. A bucket may be a range of values for an attribute, a classification, a source, or other attribute of an object that may be stored in the datastore 204a, 204b corresponding to that metastore 206a, 206b, e.g., on the same platform 200, 104 as the metastore 206a, 206b. A bucket may therefore be used to define the storage location for objects as they are received: the object is evaluated to determine which bucket the object belongs to and then stored in the datastore 204a, 204b corresponding to that bucket.

The orchestrator 106 may further configure the one or more gateways 202 with mappings at step 308. The mappings may each include a tag and a corresponding bucket. Each tag may correspond to a specific platform 200, 104. The tags may be unique relative to one another and may include any computer or human-readable identifier. A cloud computing platform 104 may include multiple regional clouds such that costs and/or delays are incurred when moving data between regional clouds. Accordingly, tags may be associated with regional clouds of a cloud computing platform. The bucket associated with a tag may include any of the buckets associated with a metastore 206a, 206b as described above: a range of values for an attribute, a classification, a source, or other attribute of an object that may be used to determine where to store the object.

The gateway 202 may receive and store the mappings at step 310 for use as discussed below. Steps 308 and 310 may include installing an operator on the one or more gateways 202 configured to evaluate the mappings as discussed below.

Following step 310, any of the one or more gateways 202 may receive a request to store an object at step 312. The bucket and corresponding tag for the object may be determined at step 314. For example, the gateway 202 may evaluate attributes of the object to determine the bucket to which the object belongs and identify the tag corresponding to that bucket according to the mappings from steps 308 and 310.

The gateway 202 will then transmit, at step 316, the object to the platform 200, 104 corresponding to the tag. At step 318, the platform 200, 104 will then store the object in the datastore 204a, 204b hosted by that platform 200, 104 and update the corresponding metastore 206a, 206b of the platform 200, 104 to reference the object. The reference to the object in the metastore 206a, 206b may include an identifier of the object and/or attributes of the object that are used to respond to queries regarding the datastore 204a, 204b.

The gateway 202 may receive a request to perform an operation with respect to the datastores 204a, 204b at step 320 and route the request to one or more platforms 200, 104 at step 322. The one or more platforms will then execute the operation at step 324 according to data referenced in the request. The one or more platforms 200, 104 may return the result of the operation to a source of the request by way of the gateway 202. For example, the operation may include a query that may be processed with respect to the metastores 206a, 206b. The operation may include a request for a specific object that includes an identifier of the object. In either case, execution of the query and retrieving the object may be performed using data stored in the metastores 206a, 206b.

Note that the operation requested at step 320 may include processing a large number of objects from a datastore 204a, 204b on a platform 200, 104 using resources of that platform 200, 104, e.g., the GPU farm of a cloud computing platform. Inasmuch as the storage location of the objects is constrained using the tags, movement of the objects to a different platform 200, 104 may be avoided. For example, the operation requested at step 320 may include training a machine learning model using the objects in a datastore 204a, 204b on a platform 200, 104 using resources of that platform 200, 104. In another example, the operating may include performing erasure coding to generate data blocks encoding an object or recovering the object from a portion of the data blocks. The data blocks encoding an object of datastore 204a, 204b of a platform 200, 104 may be stored all on that platform 200, 104 such that modification of the object and recovery of the object using the data blocks may be performed without transferring data to or from that platform 200, 104.

FIG. 4 illustrates an embodiment of a computing device 400 that may be used to implement any of the computing components described above. As shown in FIG. 4, the device 400 includes processor 410, a memory 420, a storage component 430, an input component 440, an output component 450, a communication interface 460, and a bus 470.

The processor 410, as used herein, means any type of computational circuit that may comprise hardware elements and software elements. The processor 410 may be embodied as a multi-core processor, a single core processor, or a combination of one or more multi-core processors and/or one or more single core processors, a distributed processing system, or the like. The processor 410 may be a Central Processing Unit (CPU), a graphics processing unit (GPU), an accelerated processing unit (APU), an application-specific integrated circuit (ASIC), or another type of processing component.

Memory 420 includes a non-transitory computer readable medium. Memory 420 includes a random-access memory (RAM), a read only memory (ROM), and/or another type of dynamic or static storage device (e.g., a flash memory, a magnetic memory, and/or an optical memory) that stores information and/or instructions for use by processor 410. The memory 420 comprises machine-readable instructions which are executable by the processor 410. These machine-readable instructions when executed by the processor 410 cause the processor 410 to perform one or more method steps of an embodiment described above.

Storage component 430 stores information and/or software related to the operation and use of the device 400. For example, storage component 430 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 440 is configured to receive information, such as user input. For example, the input component 440 may include, but not be limited to, a touch screen display, a keyboard, a keypad, a mouse, a button, a switch, and/or a microphone. Additionally, or alternatively, the input component 440 may include a sensor for sensing information (e.g., a global positioning system (GPS), an accelerometer, a gyroscope, and/or an actuator).

Output component 450 is configured to provide output information from the device 400. For example, the output component 450 may be, but not limited to, a display, a speaker, instructions to an external device, and/or one or more light-emitting diodes (LEDs).

Communication interface 460 is an interface that provides a communication connection to other devices, such as external devices and internal devices. The connection by the communication interface 460 can be a wired connection, a wireless connection, or a combination of wired and wireless connections, and can be a direct connection or an indirect connection via a communication network that exists between the device 400 and other devices. In other words, the standard of the communication interface 460 is not limited.

The bus 470 acts as an interconnect between the processor 410, the memory 420, the storage component 430, the input component 440, the output component 450, and the communication interface 460 of the device 400. The bus 470 may include a wired interconnection or a wireless interconnection.

The number and arrangement of components shown in FIG. 4 are provided as an example. In practice, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400. Further, one or more method steps described in any of the embodiments may be performed utilizing a plurality of devices 400 in communication with one another.

In a first example embodiment, a system for object storage includes a plurality of computing platforms each being at least one of an on-premise computing platform or a cloud computing platform, each computing platform of the plurality of computing platforms hosting a datastore and a metastore for the datastore. One or more gateways execute on one or more computing platforms of the plurality of computing platforms. The one or more gateways are configured to: receive a request to store an object; identify a bucket associated with the object according to one or more attributes associated with the object; identify a tag mapped to the bucket; and transmit the object to a corresponding computing platform of the plurality of computing platforms associated with the tag.

In a second example embodiment of the first example embodiment, the corresponding computing platform is configured to store the object in the datastore hosted by the corresponding computing platform.

In a third example embodiment of the second example embodiment, the corresponding computing platform is configured to add a reference to the object to the metastore hosted by the corresponding computing platform.

In a fourth example embodiment of the first example embodiment, the one or more gateways are configured to identify the tag mapped to the bucket according to mappings received from an orchestrator.

In a fifth example embodiment of the fourth example embodiment, the orchestrator is KUBERNETES.

In a sixth embodiment of the first example embodiment, the plurality of computing platforms host a stretch cluster spanning the plurality of computing platforms.

In seventh example embodiment of the first example embodiment, at least one computing platform of the plurality of computing platforms is configured to perform operations with respect to the datastore and the metastore hosted by the at least one computing platform.

In an eighth example embodiment of the seventh example embodiment, the at least one computing platform includes a graphics processing unit (GPU) farm and wherein the at least one computing platform is configured to perform the operations using the GPU farm.

In a ninth example embodiment of the eighth example embodiment, the operations include training a machine learning model using the datastore hosted by the at least one computing platform.

In a tenth example embodiment of the seventh example embodiment, the operations include at least one performing erasure coding of the object and performing recovery of the object using erasure coded blocks.

In eleventh example embodiment, a method for object storage includes: receiving, by a gateway, a request to store an object, the gateway being connected to a plurality of computing platforms, each computing platform of the plurality of computing platforms being at least one of an on-premise computing platform or a cloud computing platform and hosting a datastore and a metastore for the datastore; identifying, by the gateway, a bucket associated with the object according to one or more attributes associated with the object; identifying, by the gateway, a tag mapped to the bucket; and transmitting, by the gateway, the object to a corresponding computing platform of the plurality of computing platforms associated with the tag.

In a twelfth example embodiment of the eleventh example embodiment, the method further includes storing, by the corresponding computing platform, the object in the datastore hosted by the corresponding computing platform.

In a thirteenth example embodiment of the twelfth example embodiment, the method further includes adding, by the corresponding computing platform, a reference to the object to the metastore hosted by the corresponding computing platform.

In a fourteenth example embodiment of the eleventh example embodiment, the method includes identifying, by the gateway, the one or more gateways, the tag mapped to the bucket according to mappings received from an orchestrator.

In a fifteenth example embodiment of the fourteenth example embodiment, the orchestrator is KUBERNETES.

In a sixteenth example embodiment of the eleventh example embodiment, the plurality of computing platforms host a stretch cluster spanning the plurality of computing platforms.

In a seventeenth example embodiment of the eleventh example embodiment, at least one computing platform of the plurality of computing platforms is configured to perform operations with respect to the datastore and the metastore hosted by the at least one computing platform.

In an eighteenth example embodiment of the seventeenth example embodiment, the at least one computing platform includes a graphics processing unit (GPU) farm and wherein the at least one computing platform is configured to perform the operations using the GPU farm.

In a nineteenth example embodiment of the eighteenth example embodiment, wherein the operations include at least one of: training a machine learning model using the datastore hosted by the at least one computing platform; performing erasure coding of the object; or performing recovery of the object using erasure coded blocks.

In a twentieth example embodiment, a non-transitory computer readable medium storing executable code that, when executed by a computing device, causes the computing device to: receive, by a gateway, a request to store an object, the gateway being connected to a plurality of computing platforms, each computing platform of the plurality of computing platforms being at least one of an on-premise computing platforms or a cloud computing platform and hosting a datastore and a metastore for the datastore; identify, by the gateway, a bucket associated with the object according to one or more attributes associated with the object; identify, by the gateway, a tag mapped to the bucket; and transmit, by the gateway, the object to a corresponding computing platform of the plurality of computing platforms associated with the tag.

1. A system for object storage comprising:
a plurality of computing platforms each being at least one of an on-premise computing platform or a cloud computing platform, each computing platform of the plurality of computing platforms hosting a datastore and a metastore for the datastore; and
one or more gateways executing on one or more computing platforms of the plurality of computing platforms, the one or more gateways configured to:
receive a request to store an object;
identify a bucket associated with the object according to one or more attributes associated with the object;
identify a tag mapped to the bucket; and
transmit the object to a corresponding computing platform of the plurality of computing platforms associated with the tag.

2. The system of claim 1, wherein the corresponding computing platform is configured to store the object in the datastore hosted by the corresponding computing platform.

3. The system of claim 2, wherein the corresponding computing platform is configured to add a reference to the object to the metastore hosted by the corresponding computing platform.

4. The system of claim 1, wherein the one or more gateways are configured to identify the tag mapped to the bucket according to mappings received from an orchestrator.

5. The system of claim 4, wherein the orchestrator is KUBERNETES.

6. The system of claim 1, wherein the plurality of computing platforms host a stretch cluster spanning the plurality of computing platforms.

7. The system of claim 1, wherein at least one computing platform of the plurality of computing platforms is configured to perform operations with respect to the datastore and the metastore hosted by the at least one computing platform.

8. The system of claim 7, wherein the at least one computing platform includes a graphics processing unit (GPU) farm and wherein the at least one computing platform is configured to perform the operations using the GPU farm.

9. The system of claim 8, wherein the operations include training a machine learning model using the datastore hosted by the at least one computing platform.

10. The system of claim 7, wherein the operations include at least one performing erasure coding of the object and performing recovery of the object using erasure coded blocks.

11. A method for object storage comprising:
receiving, by a gateway, a request to store an object, the gateway being connected to a plurality of computing platforms, each computing platform of the plurality of computing platforms being at least one of an on-premise computing platform or a cloud computing platform and hosting a datastore and a metastore for the datastore;
identifying, by the gateway, a bucket associated with the object according to one or more attributes associated with the object;
identifying, by the gateway, a tag mapped to the bucket; and
transmitting, by the gateway, the object to a corresponding computing platform of the plurality of computing platforms associated with the tag.

12. The method of claim 11, further comprising storing, by the corresponding computing platform, the object in the datastore hosted by the corresponding computing platform.

13. The method of claim 12, further comprising adding, by the corresponding computing platform, a reference to the object to the metastore hosted by the corresponding computing platform.

14. The method of claim 11, further comprising identifying, by the gateway, the one or more gateways, the tag mapped to the bucket according to mappings received from an orchestrator.

15. The method of claim 14, wherein the orchestrator is KUBERNETES.

16. The method of claim 11, wherein the plurality of computing platforms host a stretch cluster spanning the plurality of computing platforms.

17. The method of claim 11, wherein at least one computing platform of the plurality of computing platforms is configured to perform operations with respect to the datastore and the metastore hosted by the at least one computing platform.

18. The method of claim 17, wherein the at least one computing platform includes a graphics processing unit (GPU) farm and wherein the at least one computing platform is configured to perform the operations using the GPU farm.

19. The method of claim 18, wherein the operations include at least one of:
training a machine learning model using the datastore hosted by the at least one computing platform;
performing erasure coding of the object; or
performing recovery of the object using erasure coded blocks.

20. A non-transitory computer readable medium storing executable code that, when executed by a computing device, causes the computing device to:
receive, by a gateway, a request to store an object, the gateway being connected to a plurality of computing platforms, each computing platform of the plurality of computing platforms being at least one of an on-premise computing platforms or a cloud computing platform and hosting a datastore and a metastore for the datastore;
identify, by the gateway, a bucket associated with the object according to one or more attributes associated with the object;
identify, by the gateway, a tag mapped to the bucket; and
transmit, by the gateway, the object to a corresponding computing platform of the plurality of computing platforms associated with the tag.
